(19) United States
(12) Patent Application Publication
(10) Pub. No.: US 2023/0047810 A1
(43) Pub. Date: Feb. 16, 2023

(54) APPARATUS FOR PERFORMING OTA UPDATE FOR VEHICLE, AND METHOD THEREOF

(71) Applicants: HYUNDAI MOTOR COMPANY, Seoul (KR); Kia Corporation, Seoul (KR)

(72) Inventors: Hyeok Sang JEONG, Hwaseong-si (KR); Dong Youl LEE, Seoul (KR); Hak Jun KIM, Goyang-si (KR); Jin Ah KIM, Hwaseong-si (KR); Young Jee YANG, Seongnam-si (KR); Yoon Sik JUNG, Seoul (KR); Hyung Jin JOO, Seoul (KR); Myeong Gyu JEONG, Seoul (KR)

(73) Assignees: HYUNDAI MOTOR COMPANY, Seoul (KR); Kia Corporation, Seoul (KR)

(21) Appl. No.: 17/879,026

(22) Filed: Aug. 2, 2022

(30) Foreign Application Priority Data
Aug. 13, 2021 (KR) 10-2021-0107200

(51) Int. Cl. G06F 8/65; H04L 67/00; H04L 67/12

(52) U.S. Cl. CPC G06F 8/65; H04L 67/34; H04L 67/12

(57) ABSTRACT

An apparatus for performing an over-the-air (OTA) update for a vehicle includes an estimated-time calculating device that calculates estimated time required for the OTA update of one or more controllers included in the vehicle, an update performing device that starts the OTA update based on the calculated estimated time, and a rollback performing device that performs an initial rollback on a failed OTA update once and to calculate a first value indicating whether a rollback is able to be performed on the failed OTA update in a case where the OTA update of at least one of the controllers fails when the OTA update is started.

### CROSS-REFERENCE TO RELATED APPLICATION

This application claims the benefit of priority to Korean Patent Application No. 10-2021-0107200, filed in the Korean Intellectual Property Office on Aug. 13, 2021, the entire contents of which are incorporated herein by reference.

### TECHNICAL FIELD

The present disclosure relates to an apparatus for performing an over-the-air (OTA) update for a vehicle, and a method thereof.

### BACKGROUND

In general, an over-the-air (OTA) update process may be performed for each controller included in a vehicle. Therefore, success or failure of the OTA update may depend on each controller. It is thus necessary to retry and rollback the OTA update of a controller whose OTA update has failed. However, it may be difficult to safely complete the OTA update in a case where the OTA update is started without considering an amount of battery energy required for the above-described update retry and/or update rollback.

### SUMMARY

The present disclosure has been made to solve the above-mentioned problems occurring in the related art while maintaining the advantages achieved by the related art.

An aspect of the present disclosure provides an apparatus or a method, capable of performing an over-the-air (OTA) update by scheduling the OTA update in full consideration of an amount of battery energy required for update retry and/or rollback processes performed when the OTA update fails.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an apparatus for performing an over-the-air (OTA) update for a vehicle includes an estimated-time calculating device that calculates estimated time required for the OTA update of one or more controllers included in the vehicle, an update performing device that starts the OTA update based on the calculated estimated time, and a rollback performing device that performs an initial rollback on a failed OTA update once and to calculate a first value indicating whether a rollback is able to be performed on the failed OTA update in a case where the OTA update of at least one of the one or more controllers fails when the OTA update is started.

In addition, the estimated time may be calculated based on the estimated time required for the OTA update of each of the one or more controllers, estimated time required for an OTA update retry of each of the one or more controllers, and estimated time required for an OTA update rollback of each of the one or more controllers.

In addition, the estimated time required for the OTA update retry of each of the one or more controllers may be calculated based on the estimated time required for the OTA update of each of the one or more controllers and an allowed number of the OTA update retries of each of the one or more controllers, and the estimated time required for the OTA update rollback of each of the one or more controllers may be calculated based on the estimated time required for the OTA update of each of the one or more controllers and an allowed number of the OTA update rollbacks of each of the one or more controllers.

In addition, the update performing device may start the OTA update when the calculated estimated time is less than or equal to time available for the OTA update, generated based on a value of a current state of charge (SOC) of a vehicle battery.

In addition, the first value may correspond to a difference between a second value and a third value, and the rollback performing device may further perform a rollback on the failed OTA update of at least one of the one or more controllers in a case where the first value is greater than zero when the initial rollback fails.

In addition, the second value may be calculated based on the estimated time required for the OTA update of each of the one or more controllers and the estimated time required for the OTA update retry of each of the one or more controllers, and the third value may correspond to actual time required for the OTA update of each of the one or more controllers.

In addition, the second value may correspond to a sum of the estimated time required for the OTA update of each of the one or more controllers and the estimated time required for the OTA update retry of each of the one or more controllers.

In addition, the second value may be calculated based on a maximum allowed number of the OTA updates and a maximum allowed number of the OTA update retries, and the third value may correspond to a number of at least one controller whose OTA update is completed.

In addition, the second value may correspond to a sum of the maximum allowed number of the OTA updates and the maximum allowed number of the OTA update retries.

In addition, the maximum allowed number of the OTA updates may correspond to a number of the one or more controllers included in the vehicle, and the maximum allowed number of the OTA update retries may indicate a value obtained by multiplying the number of the one or more controllers by the allowed number of the OTA update retries of each of the one or more controllers.

According to another aspect of the present disclosure, a method of performing an over-the-air (OTA) update for a vehicle includes: calculating, by an estimated-time calculating device, estimated time required for the OTA update of one or more controllers included in the vehicle; starting, by an update performing device, the OTA update based on the calculated estimated time; and performing, by a rollback performing device, an initial rollback on a failed OTA update once and calculating a first value indicating whether a rollback is able to be performed on the failed OTA update in a case where the OTA update of at least one of the one or more controllers fails when the OTA update is started.

In addition, the estimated time may be calculated based on the estimated time required for the OTA update of each of the one or more controllers, estimated time required for an OTA update retry of each of the one or more controllers, and estimated time required for an OTA update rollback of each of the one or more controllers.

In addition, the estimated time required for the OTA update retry of each of the one or more controllers may be calculated based on the estimated time required for the OTA update of each of the one or more controllers and an allowed number of the OTA update retries of each of the one or more controllers, and the estimated time required for the OTA update rollback of each of the one or more controllers may be calculated based on the estimated time required for the OTA update of each of the one or more controllers and an allowed number of the OTA update rollbacks of each of the one or more controllers.

In addition, the starting of the OTA update may include starting, by the update performing device, the OTA update when the calculated estimated time is less than or equal to time available for the OTA update, generated based on a value of a current state of charge (SOC) of a vehicle battery.

In addition, the first value may correspond to a difference between a second value and a third value, and the calculating of the first value may further include performing, by the rollback performing device, a rollback on the failed OTA update of at least one of the one or more controllers in a case where the first value is greater than zero when the initial rollback fails.

In addition, the second value may be calculated based on the estimated time required for the OTA update of each of the one or more controllers and the estimated time required for the OTA update retry of each of the one or more controllers, and the third value may correspond to actual time required for the OTA update of each of the one or more controllers.

In addition, the second value may correspond to a sum of the estimated time required for the OTA update of each of the one or more controllers and the estimated time required for the OTA update retry of each of the one or more controllers.

In addition, the second value may be calculated based on a maximum allowed number of the OTA updates and a maximum allowed number of the OTA update retries, and the third value may correspond to a number of at least one controller whose OTA update is completed.

In addition, the second value may correspond to a sum of the maximum allowed number of the OTA updates and the maximum allowed number of the OTA update retries.

In addition, the maximum allowed number of the OTA updates may correspond to a number of the one or more controllers included in the vehicle, and the maximum allowed number of the OTA update retries may indicate a value obtained by multiplying the number of the one or more controllers by the allowed number of the OTA update retries of each of the one or more controllers.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of an environment in which an apparatus for performing an over-the-air (OTA) update for a vehicle is operated according to embodiments;

FIG. 2 shows an example of an apparatus for performing an OTA update for a vehicle according to embodiments;

FIG. 3 is a view showing an example of an OTA update process performed by an apparatus for performing an OTA update for a vehicle according to embodiments;

FIG. 4 is a flowchart showing an example of a method of performing an OTA update for a vehicle according to embodiments; and

FIG. 5 is a flowchart showing an example of the method of performing an OTA update for a vehicle according to embodiments.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it may interfere with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

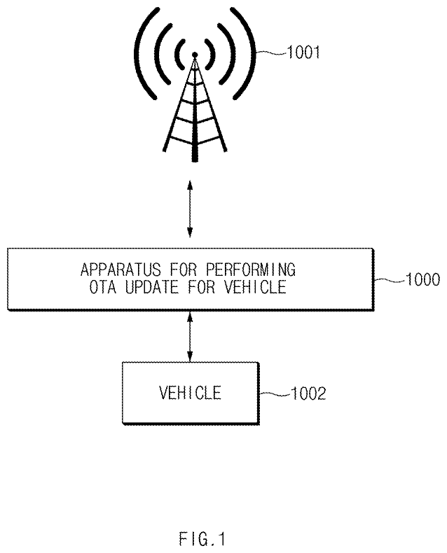

Hereinafter, embodiments of the present disclosure are described in detail with reference to FIGS. 1 to 5.

FIG. 1 shows an example of an environment in which an apparatus for performing an over-the-air (OTA) update for a vehicle is operated according to embodiments.

This drawing is provided to explain an example of the environment in which an apparatus 1000 for performing an OTA update for a vehicle is operated according to embodiments.

A vehicle 1002 according to embodiments may include at least one of an electric vehicle (EV), a hybrid electric vehicle (HEV) or a plug-in hybrid electric vehicle (PHEV).

The OTA update according to embodiments may be a method of updating software of a vehicle by using a wireless communication network. In general, a software update of the vehicle may be performed by connecting a storage apparatus storing data for the software update to the vehicle by wire. However, with development of communication technology, the vehicle may directly receive and update the data required for the software update by using the wireless communication network.

The apparatus according to embodiments may receive information on the OTA update from a server 1001. The information on the OTA update according to embodiments may be information on performing the above-described OTA update. For example, the information on the OTA update may include information on a software package, information on a software version, etc.

The vehicle according to embodiments may include one or more controllers. The controller according to embodiments may be an apparatus which is included in the vehicle and performs a specific function. For example, the controller may be an electronic control unit (ECU) included in the vehicle.

The OTA update according to embodiments may be performed for each of the above-described controllers. That is, the OTA update may be performed separately for each controller.

The apparatus according to embodiments may receive the information on the above-described OTA update from the server, and may perform the OTA update of the controller(s) included in the vehicle. The apparatus according to embodiments may be positioned inside or outside the vehicle.

The apparatus according to embodiments may wirelessly update software of the controller(s) included in the vehicle by means of the OTA update shown in this drawing. That is, the apparatus may update the software of the controller by using the OTA method to allow the controller to have a newly added function, a reduced existing error and/or enhanced security.

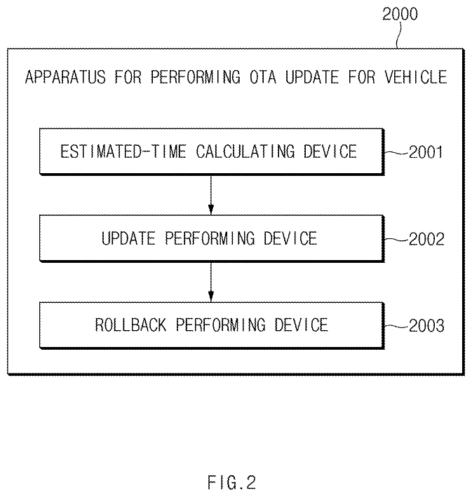

FIG. 2 shows an example of an apparatus for performing an OTA update for a vehicle according to embodiments.

This drawing is a block diagram showing an example of an apparatus 2000 (which is the same as the apparatus described in FIG. 1) for performing an OTA update for a vehicle according to embodiments.

As described above with reference to FIG. 1, the apparatus according to embodiments may pertain the OTA update of one or more controllers included in a vehicle.

In general, an OTA update process may be performed for each controller included in the vehicle. Therefore, the success or failure of the OTA update may depend on each controller. It is thus necessary to retry and roll back the OTA update of a controller whose OTA update fails. However, it may be difficult to safely complete the OTA update in a case where the OTA update is started without considering an amount of battery energy required for the above-described update retry and/or update rollback.

The apparatus according to embodiments may perform the OTA update by scheduling the OTA update in full consideration of an amount of battery energy required for the update retry and/or update rollback processes caused by the failure of the OTA update.

The apparatus according to embodiments may include an estimated-time calculating device 2001, an update performing device 2002, and/or a rollback performing device 2003. As described with reference to FIG. 1, the apparatus may be positioned inside or outside the vehicle. The apparatus according to embodiments may further include one or more elements not shown in this drawing.

The estimated-time calculating device according to embodiments may calculate estimated time required for the OTA update of one or more controllers (described with reference to FIG. 1) included in the vehicle. The estimated time according to embodiments may be a value of the estimated time taken until every controller included in the vehicle completes the OTA update. For example, the estimated time may be a value of the estimated time taken for all of ten controllers included in the vehicle to complete the OTA update.

The estimated time according to embodiments may be calculated based on the estimated time required for the OTA update of each of the controllers, estimated time required for an OTA update retry of each of the controllers, and estimated time required for the OTA update rollback of each of the controllers. For example, the estimated time according to embodiments may be a sum of the estimated time required for the OTA update of each of the above-described controllers, the estimated time required for the OTA update retry of each of the controllers, and the estimated time required for the OTA update rollback of each of the controllers.

The estimated time required for the OTA update of each of the controllers according to embodiments may be a value of an estimated time taken for each controller to perform a first OTA update. For example, the estimated time required for the OTA update of each of the controllers according to embodiments may be a sum of the estimated time taken for each controller to perform the first OTA update.

The estimated time required for the OTA update retry of each of the controllers according to embodiments may be a value of an estimated time taken for each controller to retry the OTA update when the first OTA update fails. For example, the estimated time required for the OTA update retry of each of the controllers according to embodiments may be a sum of the estimated time taken for the controller(s) whose first OTA update fails to retry the OTA update.

The estimated time required for the OTA update retry of each of the controllers may be calculated based on the estimated time required for the OTA update of each of the controllers and the allowed number of the OTA update retries of each of the controllers. For example, the estimated time required for the OTA update retry of each of the controllers may be a value obtained by multiplying the estimated time required for the OTA update of each of the controllers by the allowed number of the OTA update retries of each of the controllers.

The allowed number of the OTA update retries of each of the controllers according to embodiments may have a preset value or may have a value input by a user (or a driver of the vehicle). For example, one may be the allowed number of the OTA update retries of each of the controllers.

The estimated time required for the OTA update rollback of each of the controllers according to embodiments may be a value of an estimated time taken for each controller to roll the OTA update back when the OTA update of each controller fails or the retried OTA update fails. For example, the estimated time required for the OTA update rollback of each of the controllers may be a sum of the time taken for the controller(s) whose retried OTA update fails to roll the OTA update back.

The rollback according to embodiments may indicate that the controller returns to a previous state when the OTA update fails due to an error in the OTA update process of the controller. The rollback according to embodiments may be referred to as a reverse return.

The estimated time required for the OTA update rollback of each of the controllers may be calculated based on the estimated time required for the OTA update of each of the controllers and the allowed number of the OTA update rollbacks of each of the controllers. For example, the estimated time required for the OTA update rollback of each of the controllers may have a value obtained by multiplying the estimated time required for the OTA update of each of the controllers by the allowed number of the OTA update rollbacks of each of the controllers.

The allowed number of the OTA update rollbacks of each of the controllers according to embodiments may have a preset value or may have a value input by the user (or the driver of the vehicle). For example, one may be the allowed number of the OTA update rollbacks of each of the controllers.

That is, as described above, the estimated time according to embodiments may be an estimated time calculated by considering all of the first try, retry and/or rollback processes of the OTA update of the controllers.

The update performing device according to embodiments may start the OTA update based on the calculated estimated time. For example, the update performing device may start the OTA update when the calculated estimated time is less than or equal to time available for the OTA update, generated based on a value of a current state of charge (SOC) of a vehicle battery.

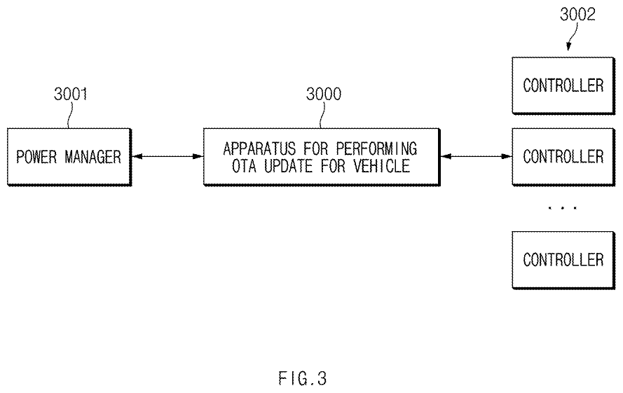

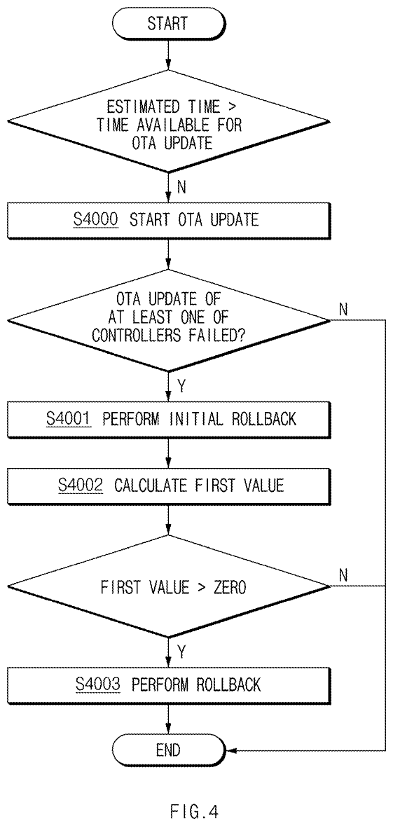

The rollback performing device according to embodiments may calculate a first value indicating whether the rollback may be performed on the failed OTA update of the controller in a case where the OTA update of at least one of the controllers fails when the OTA update is started. That is, the rollback performing device may determine whether to perform the rollback for the controller whose OTA update fails based on the first value. A detailed description of the first value according to embodiments is described below with reference to FIGS. 3 and 4.

The apparatus according to embodiments may perform the OTA update of the controller(s) by scheduling the OTA update in consideration of all the processes of the first OTA update, OTA update retry and/or OTA update rollback of the controller, by using the method described with reference to this drawing. That is, the apparatus may safely complete the OTA update by estimating a maximum amount of the battery energy that may be used in the OTA update process by scheduling the OTA update described above.

FIG. 3 is a view showing an example of the OTA update process performed by an apparatus for performing an OTA update for a vehicle according to embodiments.

This drawing is provided to explain an example of the OTA update process performed by the apparatus (which is same as the apparatuses described in FIGS. 1 and 2) for performing an OTA update for a vehicle according to embodiments.

As described above with reference to FIGS. 1 and 2, an apparatus 3000 according to embodiments may perform the OTA update of one or more controllers 3002 included in the vehicle. The controllers according to embodiments may be included in the vehicle. The apparatus according to embodiments may be included in the vehicle or positioned outside the vehicle.

As described above with reference to FIG. 2, the update performing device 2002 (in FIG. 2) according to embodiments may start the OTA update based on the calculated estimated time. For example, the update performing device may start the OTA update when the calculated estimated time is less than or equal to the time available for the OTA update, generated based on the value of the current state of charge (SOC) of the vehicle battery.

A power manager 3001 may generate the time available for the OTA update, generated based on the above-described value of the current SOC of the battery. For example, the power manager may check the value of the current SOC of the battery and calculate maximum time available for the OTA update based on the checked value of the SOC.

As described above with reference to FIG. 2, the rollback performing device 2003 (in FIG. 2) according to embodiments may perform the rollback.

The rollback according to embodiments may be performed when the OTA update fails and/or when the retried OTA update fails. That is, the rollback performed by the rollback performing device may be performed for the controller whose OTA update and/or retried OTA update fails.

As described above with reference to FIG. 2, the rollback performing device according to embodiments may perform the rollback based on the calculated first value. For example, the rollback performing device may perform an initial rollback on the failed OTA update once when the OTA update of the controller fails, and perform a rollback on the failed OTA update of the controller in a case where the calculated first value is greater than zero when the initial rollback fails.

According to these embodiments, it is guaranteed that the rollback may always be performed once for every controller whose OTA update fails.

The first value according to embodiments may be a value indicating whether there is room (e.g., value of the SOC of the battery) for the apparatus to perform the rollback. The first value according to embodiments may correspond to a difference between a second value and a third value.

The second value according to embodiments may indicate an estimated time calculated considering the first OTA update and the OTA update retry. The second value may be calculated based on the estimated time required for the OTA update of each of the controllers and the estimated time required for the OTA update retry of each of the controllers. For example, the second value may correspond to a sum of the estimated time required for the OTA update of each of the controllers and the estimated time required for the OTA update retry of each of the controllers.

The third value according to embodiments may correspond to actual time required for the OTA update of each of the controllers.

That is, the first value according to embodiments may be a value obtained by subtracting the actual time required for the OTA update from the estimated time required for the OTA update retry.

Accordingly, the rollback performing device may perform the rollback for the controller whose OTA update finally fails when the above-described first value is greater than zero.

In addition, the second value according to embodiments may be a value indicating the estimated number of the OTA updates considering the first OTA update and the OTA update retry. The second value may be calculated based on a maximum allowed number of the OTA updates and a maximum allowed number of the OTA update retries. For example, the second value may correspond to a sum of the maximum allowed number of the OTA updates and the maximum allowed number of the OTA update retries.

The maximum allowed number of the OTA updates according to embodiments may correspond to the number of one or more controllers included in the vehicle. The maximum allowed number of the OTA update retries according to embodiments may indicate a value obtained by multiplying the number of the controllers by the allowed number of the OTA update retries of each of the controllers. A detailed description of the value multiplied by the allowed number of the OTA update retries of each of the controllers is the same as or similar to those described above.

The third value according to embodiments may correspond to the number of at least one controller whose OTA update is completed.

That is, in this case, the first value according to embodiments may be a value obtained by subtracting the number of the OTA updates actually performed from the estimated number of the OTA updates considering even the OTA update retry.

Accordingly, the rollback pertaining device may perform the rollback for the controller whose OTA update finally fails when the above-described first value is greater than zero.

The rollback according to embodiments may be performed in an order opposite to that of the above-described OTA update. For example, the first OTA update of a first controller may be performed, and the first OTA update of a second controller may then be performed. Here, the rollback process of the second controller may be performed before that of the first controller when the OTA update of both the first and second controllers finally fail.

The apparatus according to embodiments may perform the OTA update of the controller(s) by scheduling the OTA update in consideration of all the processes of the first OTA update, OTA update retry and/or OTA update rollback of the controller, by using the method described with reference to this drawing. That is, the apparatus may safely complete the OTA update by estimating the maximum amount of the battery energy that may be used in the OTA update process by scheduling the OTA update described above.

The estimated-time calculating device, update performing device, and rollback performing device may each include at least one memory storing instructions for the method disclosed herein and at least one processor to execute the instructions.

FIG. 4 is a flowchart showing an example of a method of performing an OTA update for a vehicle according to embodiments.

This drawing is a flowchart showing an example of the method of performing an OTA update for a vehicle according to embodiments.

The method according to embodiments may be implemented by the apparatus described above with reference to FIGS. 1 to 3.

As described above with reference to FIGS. 1 to 3, the apparatus (e.g., update performing device) according to embodiments may start the OTA update (S4000) when a calculated estimated time is less than or equal to time available for the OTA update, generated based on a value of a current state of charge (SOC) of a vehicle battery.

Detailed descriptions of the calculated estimated time, the generated time available for the OTA update, and the OTA update are the same as or similar to those described above with reference to FIGS. 1 to 3.

The apparatus (e.g., rollback performing device) according to embodiments may perform an initial rollback (S4001) once in a case where the OTA update of at least one of the controllers fails when the OTA update is started.

The apparatus (e.g., rollback performing device) according to embodiments may calculate a first value (S4002) indicating whether a rollback may be performed on the failed OTA update of the controller.

Detailed descriptions of the rollback and the first value are the same as or similar to those described above with reference to FIGS. 1 to 3.

The apparatus (e.g., rollback performing device) according to embodiments may perform a rollback (S4003) on the failed OTA update of the controller in a case where the calculated first value is greater than zero when the initial rollback fails.

A detailed description of a process in which the apparatus performs the rollback is the same as or similar to that described above with reference to FIGS. 1 to 3.

The apparatus according to embodiments may perform the OTA update of the controller(s) by scheduling the OTA update in consideration of all the processes of the first OTA update, OTA update retry and/or OTA update rollback of the controller, by using the method described with reference to this drawing. That is, the apparatus may safely complete the OTA update by estimating the maximum amount of the battery energy that may be used in the OTA update process by scheduling the OTA update described above.

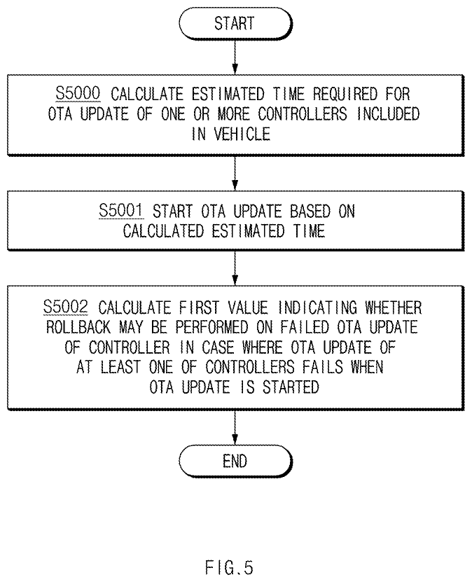

FIG. 5 is a flowchart showing an example of the method of performing an OTA update for a vehicle according to embodiments.

This drawing is a flowchart showing another example of the method of performing an OTA update for a vehicle according to embodiments.

The apparatus described above with reference to FIGS. 1 to 4 may perform the method described with reference to this drawing.

The method of performing an OTA update for a vehicle according to embodiments may include calculating estimated time required for the OTA update of one or more controllers included in the vehicle (S5000), starting the OTA update based on the calculated estimated time (S5001), and calculating the first value indicating whether the rollback may be performed on the failed OTA update of the controller in a case where the OTA update of at least one of the controllers fails when the OTA update is started (S5002). The method according to embodiments may further include one or more steps not shown in this drawing.

The estimated time according to embodiments may be calculated based on the estimated time required for the OTA update of each of the controllers, estimated time required for the OTA update retry of each of the controllers, and estimated time required for the OTA update rollback of each of the controllers.

Detailed descriptions of the OTA update, the estimated time, the rollback and the first value are the same as or similar to those described above with reference to FIGS. 1 to 4.

The estimated time required for the OTA update retry of each of the controllers may be calculated based on the estimated time required for the OTA update of each of the controllers and the allowed number of the OTA update retries of each of the controllers.

The estimated time required for the OTA update rollback of each of the controllers may be calculated based on the estimated time required for the OTA update of each of the controllers and the allowed number of the OTA update rollbacks of each of the controllers.

Detailed descriptions of the estimated time required for the OTA update retry of each of the controllers and the estimated time required for the OTA update rollback of each of the controllers are the same as or similar to those described above with reference to FIGS. 1 to 4.

S5001 according to embodiments may include starting the OTA update when the calculated estimated time is less than or equal to the time available for the OTA update, generated based on the value of the current state of charge (SOC) of the vehicle battery. A description of the above step is the same as or similar to that described above with reference to FIGS. 1 to 4.

The first value according to embodiments may correspond to a difference between a second value and a third value.

The calculating of the first value according to embodiments may include performing the rollback on the failed OTA update of the controller when the first value is greater than zero.

The second value may be calculated based on the estimated time required for the OTA update of each of the controllers and the estimated time required for the OTA update retry of each of the controllers.

The third value according to embodiments may correspond to actual time required for the OTA update of each of the controllers.

The second value according to embodiments may correspond to a sum of the estimated time required for the OTA update of each of the controllers and the estimated time required for the OTA update retry of each of the controllers.

The second value according to embodiments may be calculated based on a maximum allowed number of the OTA updates and a maximum allowed number of the OTA update retries.

The third value according to embodiments may correspond to the number of at least one controller whose OTA update is completed.

The second value according to embodiments may correspond to a sum of the maximum allowed number of the OTA updates and the maximum allowed number of the OTA update retries.

Detailed descriptions of the first value, the second value and the third value are the same as or similar to those described above with reference to FIGS. 1 to 4.

The maximum allowed number of the OTA updates according to embodiments may correspond to the number of one or more controllers included in the vehicle.

The maximum allowed number of the OTA update retries according to embodiments may indicate a value obtained by multiplying the number of the controllers by the allowed number of the OTA update retries of each of the controllers.

Detailed descriptions of the maximum allowed number of the OTA updates and the maximum allowed number of the OTA update retries are the same as or similar to those described above with reference to FIGS. 1 to 4.

The apparatus according to embodiments may perform the OTA update of the controller(s) by scheduling the OTA update in consideration of all the processes of the first OTA update, OTA update retry and/or OTA update rollback of the controller, by using the method described with reference to this drawing. That is, the apparatus may safely complete the OTA update by estimating the maximum amount of the battery energy that may be used in the OTA update process by scheduling the OTA update described above.

As set forth above, the apparatus according to embodiments may perform the OTA update by scheduling the OTA update in full consideration of the amount of battery energy required for the update retry and/or rollback processes performed when the OTA update fails.

In addition, there may be a variety of effects identified directly or indirectly from the present disclosure.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for performing an over-the-air (OTA) update for a vehicle, the apparatus comprising:
an estimated-time calculating device configured to calculate estimated time required for the OTA update of one or more controllers included in the vehicle;
an update performing device configured to start the OTA update based on the calculated estimated time; and
a rollback performing device configured to perform an initial rollback on a failed OTA update once and to calculate a first value indicating whether a rollback is able to be performed on the failed OTA update in a case where the OTA update of at least one of the one or more controllers fails when the OTA update is started.

2. The apparatus of claim 1, wherein the estimated time is calculated based on the estimated time required for the OTA update of each of the one or more controllers, estimated time required for an OTA update retry of each of the one or more controllers, and estimated time required for an OTA update rollback of each of the one or more controllers.

3. The apparatus of claim 2, wherein the estimated time required for the OTA update retry of each of the one or more controllers is calculated based on the estimated time required for the OTA update of each of the one or more controllers and an allowed number of the OTA update retries of each of the one or more controllers, and
the estimated time required for the OTA update rollback of each of the one or more controllers is calculated based on the estimated time required for the OTA update of each of the one or more controllers and an allowed number of the OTA update rollbacks of each of the one or more controllers.

4. The apparatus of claim 1, wherein the update performing device is configured to start the OTA update when the calculated estimated time is less than or equal to time available for the OTA update, generated based on a value of a current state of charge (SOC) of a vehicle battery.

5. The apparatus of claim 3, wherein the first value corresponds to a difference between a second value and a third value, and
the rollback performing device is further configured to perform a rollback on the failed OTA update of at least one of the one or more controllers in a case where the first value is greater than zero when the initial rollback fails.

6. The apparatus of claim 5, wherein the second value is calculated based on the estimated time required for the OTA update of each of the one or more controllers and the estimated time required for the OTA update retry of each of the one or more controllers, and
the third value corresponds to actual time required for the OTA update of each of the one or more controllers.

7. The apparatus of claim 6, wherein the second value corresponds to a sum of the estimated time required for the OTA update of each of the one or more controllers and the estimated time required for the OTA update retry of each of the one or more controllers.

8. The apparatus of claim 5, wherein the second value is calculated based on a maximum allowed number of the OTA updates and a maximum allowed number of the OTA update retries, and
the third value corresponds to a number of at least one controller whose OTA update is completed.

9. The apparatus of claim 8, wherein the second value corresponds to a sum of the maximum allowed number of the OTA updates and the maximum allowed number of the OTA update retries.

10. The apparatus of claim 8, wherein the maximum allowed number of the OTA updates corresponds to a number of the one or more controllers included in the vehicle, and
the maximum allowed number of the OTA update retries indicates a value obtained by multiplying the number of the one or more controllers by the allowed number of the OTA update retries of each of the one or more controllers.

11. A method of performing an over-the-air (OTA) update for a vehicle, the method comprising:
calculating, by an estimated-time calculating device, estimated time required for the OTA update of one or more controllers included in the vehicle;
starting, by an update performing device, the OTA update based on the calculated estimated time; and
performing, by a rollback performing device, an initial rollback on a failed OTA update once and calculating a first value indicating whether a rollback is able to be performed on the failed OTA update in a case where the OTA update of at least one of the one or more controllers fails when the OTA update is started.

12. The method of claim 11, wherein the estimated time is calculated based on the estimated time required for the OTA update of each of the one or more controllers, estimated time required for an OTA update retry of each of the one or more controllers, and estimated time required for an OTA update rollback of each of the one or more controllers.

13. The method of claim 12, wherein the estimated time required for the OTA update retry of each of the one or more controllers is calculated based on the estimated time required for the OTA update of each of the one or more controllers and an allowed number of the OTA update retries of each of the one or more controllers, and
the estimated time required for the OTA update rollback of each of the one or more controllers is calculated based on the estimated time required for the OTA update of each of the one or more controllers and an allowed number of the OTA update rollbacks of each of the one or more controllers.

14. The method of claim 11, wherein the starting of the OTA update includes starting, by the update performing device, the OTA update when the calculated estimated time is less than or equal to time available for the OTA update, generated based on a value of a current state of charge (SOC) of a vehicle battery.

15. The method of claim 13, wherein the first value corresponds to a difference between a second value and a third value, and
the calculating of the first value further includes performing, by the rollback performing device, a rollback on the failed OTA update of at least one of the one or more controllers in a case where the first value is greater than zero when the initial rollback fails.

16. The method of claim 15, wherein the second value is calculated based on the estimated time required for the OTA update of each of the one or more controllers and the estimated time required for the OTA update retry of each of the one or more controllers, and
the third value corresponds to actual time required for the OTA update of each of the one or more controllers.

17. The method of claim 16, wherein the second value corresponds to a sum of the estimated time required for the OTA update of each of the one or more controllers and the estimated time required for the OTA update retry of each of the one or more controllers.

18. The method of claim 15, wherein the second value is calculated based on a maximum allowed number of the OTA updates and a maximum allowed number of the OTA update retries, and
the third value corresponds to a number of at least one controller whose OTA update is completed.

19. The method of claim 18, wherein the second value corresponds to a sum of the maximum allowed number of the OTA updates and the maximum allowed number of the OTA update retries.

20. The method of claim 18, wherein the maximum allowed number of the OTA updates corresponds to a number of the one or more controllers included in the vehicle, and
the maximum allowed number of the OTA update retries indicates a value obtained by multiplying the number of the one or more controllers by the allowed number of the OTA update retries of each of the one or more controllers.
